(19) United States
(12) Patent Application Publication
(10) Pub. No.: US 2012/0331495 A1
(43) Pub. Date: Dec. 27, 2012

(54) APPARATUS AND METHOD FOR PROVIDING SERVICE USING A PORTABLE TERMINAL IN TELEVISION

(75) Inventor: Ju-Ho Hyun, Suwon-si (KR)

(73) Assignee: Samsung Electronics Co., Ltd., Suwon-si (KR)

(21) Appl. No.: 13/531,379

(22) Filed: Jun. 22, 2012

(30) Foreign Application Priority Data
Jun. 22, 2011 (KR) 10-2011-0060634

(51) Int. Cl. H04N 21/258; H04N 21/472

(52) U.S. Cl. 725/10; 725/86

(57) ABSTRACT

According to one embodiment, a method for providing a service using a portable terminal in communication with a television (TV) includes analyzing an image inputted from a camera to determine the number of users, collect user information from a terminal, and determine a type of a service to be provided based on the number of users and the collected user information.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jun. 22, 2011 and assigned Serial No. 2011-0060634, the entire disclosure of which is hereby incorporated by reference.

### TECHNICAL FIELD OF THE INVENTION

The present invention generally relates to communication devices, and more particularly, to an apparatus and method for providing a service using a portable terminal in communication with a television (TV).

### BACKGROUND OF THE INVENTION

The conventional digital TV is an apparatus for providing a multimedia broadcast service to a user. The conventional digital TV typically operates in a passive manner in which the user selects and switches a channel manually to view the selected channel. In contrast, the smart TV does not operate passively according to a user's selection but rather analyzes and provides desired multimedia content without the user's manipulation. That is, functions such as a allowing the smart TV and a portable terminal of a user to communicate with each other and provide services of the portable terminal using a large screen of the smart TV.

Generally, since a portable terminal is an apparatus of an individual user while a TV is an apparatus shared by a plurality of users, it may be difficult for the TV to provide a service customized for an individual using only user information. Therefore, it may be required to provide a service customized for the TV using information in the portable terminal that can represent an individual characteristic to a relatively high degree. However, when a service provided by the portable terminal is directly provided via the TV, the privacy of an individual user may not be protected. For example, though a particular message received in the portable terminal may include relatively private information, the message may be displayed on a screen of the TV while a plurality of users view the TV such that the private information is exposed to other users.

### SUMMARY OF THE INVENTION

To address the above-discussed deficiencies of the prior art, it is a primary object to provide at least the advantages described below. Accordingly, an aspect of the present disclosure is to provide a method and an apparatus for recognizing a user of a portable terminal and providing a service using a television (TV).

Another aspect of the present disclosure is to provide a method and an apparatus for determining the number of nearby users via a camera, receiving user information from a portable terminal, and determining whether to provide a personal service or a common service using a TV.

Still another aspect of the present disclosure is to provide a method and an apparatus for collecting user operation information in real-time from a portable terminal, and providing a service corresponding to the collected user operating information.

In accordance with an aspect of the present disclosure, a method for providing a service using a portable terminal in a television (TV) includes analyzing an image inputted from a camera to determine the number of users, collecting user information of one or more terminals, and determining a kind of service to be provided based on the number of users and the collected user information.

In accordance with another aspect of the present disclosure, a method for providing a service by a portable terminal in communication with a television (TV) includes receiving a user information request signal from the TV, transmitting user information of the portion terminal, and transmitting operating information related to an operation of the terminal to the TV.

In accordance with still another aspect of the present disclosure, a television TV) configured to provide a service using a portable terminal includes a camera configured to receive an image, a communication unit configured to collect user information of a terminal, and a controller configured to analyze the image inputted from the camera to determine the number of users, and determine a kind of a service to be provided based on the number of users and the collected user information.

In accordance with yet another aspect of the present disclosure, a portable terminal configured to provide a service in communication with a television (TV) includes a communication unit configured to transmit or receive a signal to and from, respectively, the TV, and a controller configured to, when receiving a user information request signal from the TV via the communication unit, transmit user information of the terminal to the TV, and transmit operation information related to an operation of the terminal to the TV.

Other aspects, advantages and salient features of the disclosure will become apparent to those skilled in the art from the following detailed description, which, taken in conjunction with the annexed drawings, discloses embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example system for providing a TV and a portable terminal that communicates with each other to provide a service according to an embodiment of the present disclosure;

FIG. 2A illustrates an example technique for providing a personal service using a TV according to an embodiment of the present disclosure;

FIG. 2B illustrates an example for providing a common service using a TV according to an embodiment of the present disclosure;

FIG. 3 illustrates an example TV according to an embodiment of the present disclosure;

FIG. 4 illustrates an example portable terminal according to an embodiment of the present disclosure;

FIG. 5 illustrates an example procedure for operating a TV according to an embodiment of the present disclosure; and

FIG. 6 illustrates an example procedure for operating a portable terminal according to an embodiment of the present disclosure.

Throughout the drawings, like reference numerals will be understood to refer to like parts, components and structures.

### DETAILED DESCRIPTION OF THE INVENTION

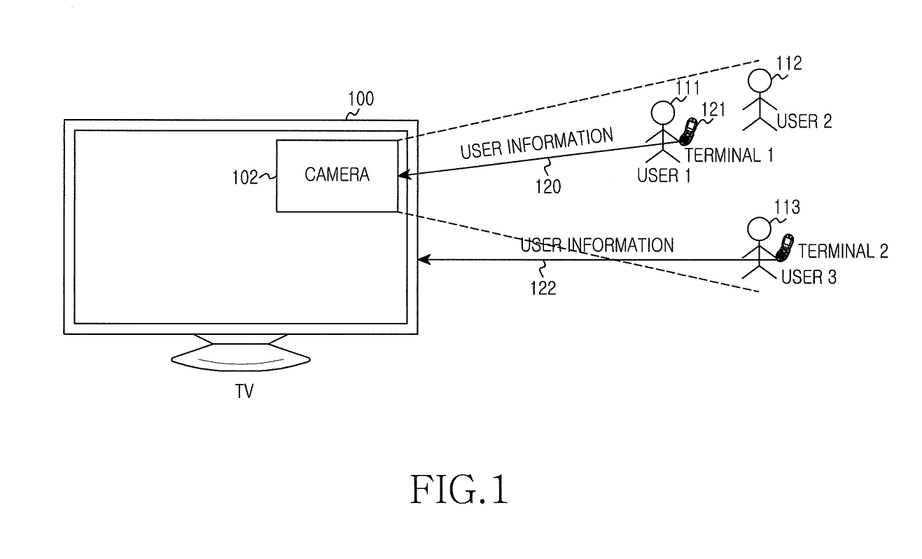

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. The following description with reference to the accompanying drawings is provided to assist in a comprehensive understanding of embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of embodiments of the present disclosure is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terms and words used in the following description and claims are not limited to the bibliographical meanings, but, are merely used by the inventor to enable a clear and consistent understanding of the invention. Accordingly, it should be apparent to those skilled in the art that the following description of embodiments of the present invention are provided for illustration purpose only and not for the purpose of limiting the invention as defined by the appended claims and their equivalents.

Embodiments of the present disclosure provide a method and an apparatus for recognizing a user of a portable terminal to provide a service in a smart TV. In the following description, a personal service denotes a service related to a user's private life, and a common service denotes a service having nothing to do with the user's private life. A standard for discriminating between the personal service and the common service may be defined and changed by a design scheme and a user.

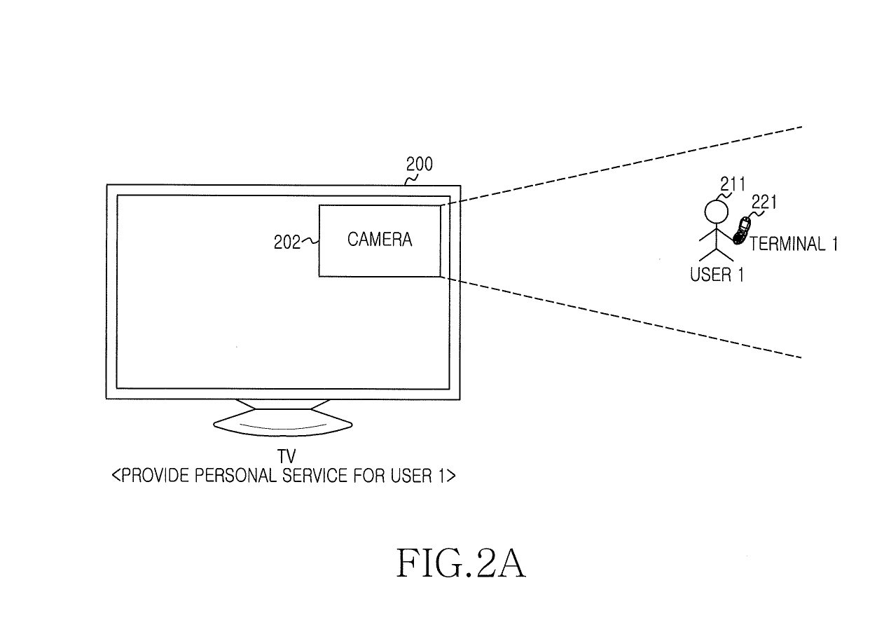

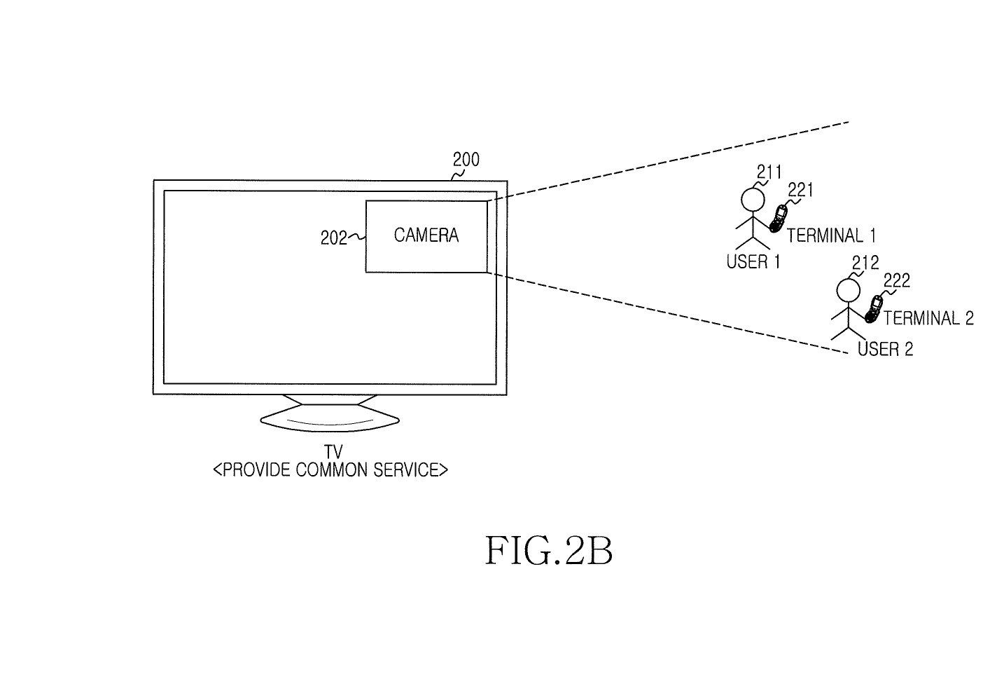

FIG. 1 illustrates an example system for providing a TV and a portable terminal that communicate with each other to provide a service according to an embodiment of the present disclosure, and FIGS. 2A and 2B illustrate an example technique of providing a personal service and a common service, respectively, using a TV according to embodiments of the present disclosure.

Referring to FIG. 1, a TV 100 includes a camera 102 to determine the number of users 111 to 113 within a viewing range of an image inputted via the camera 102. The TV 100 collects (120 and 122) user information from the user's terminals 121 and 122 determines whether one user carrying a terminal with him exists in the vicinity of the TV 100.

When one user carrying a terminal exists in the vicinity of the TV, the TV 100 collects user operating information in real-time from the terminal carried by the one user, and provides a personal service for the user depending on the collected operating information. For example, operating information may include whether a terminal is currently in use, login information, applications currently in use, a search keyword, message transmission/reception information, call reception/transmission information, communication counterpart information, and the like.). That is, as illustrated in FIG. 2A, when a USER 1 211 carrying a TERMINAL 1 221 exists in the vicinity of a TV 200, the TV 200 detects existence of the USER 1 211 via a camera 202, and collects user operating information from the TERMINAL 1 221 to provide the personal service for the USER 1 211 depending on the collected user operating information. The personal service may include a service that displays a short message or a multimedia message received in the TERMINAL 1 221 on a screen of the TV 200, a service that displays a message transmitted or received via a Social Network Service (SNS) on the screen of the TV 200, a service that displays information regarding a communication counterpart on the screen of the TV 200, and the like. Nevertheless, the personal service is not limited to only these examples, but may include any service provided by a portable terminal, such as services related to an individual user's private life.

In contrast, when one user carrying a terminal does not exist in the vicinity of the TV; that is, when a plurality of users exist in the vicinity of the TV, the TV collects user operating information in real-time from a nearby terminal, and provides a common service depending on the user operating information. That is, as illustrated in FIG. 2B, when the USER 1 211 carrying the TERMINAL 1 221 and a USER 2 212 carrying a TERMINAL 2 222 exist in the vicinity of the TV 200, the TV 200 detects existence of the USER 1 211 and the USER 2 212 via the camera 202, and collects user operating information from the TERMINAL 1 221 and the TERMINAL 2 222 to provide a common service for the USER 1 211 and the USER 2 212 depending on the collected user operating information. The common service may include a contents recommend service regarding a common interest of the USER 1 211 and the USER 2 212, a service representing information regarding TV view contents for a common interest, a message or call reception inform service, and the like. At this point, the common interest may be extracted from operating information collected from the TERMINAL 1 221 and the TERMINAL 2 222. The common service is not limited to the above-described examples, but may include a service provided by the portable terminal and services not related to an individual user's private life among services that can be provided using user operating information.

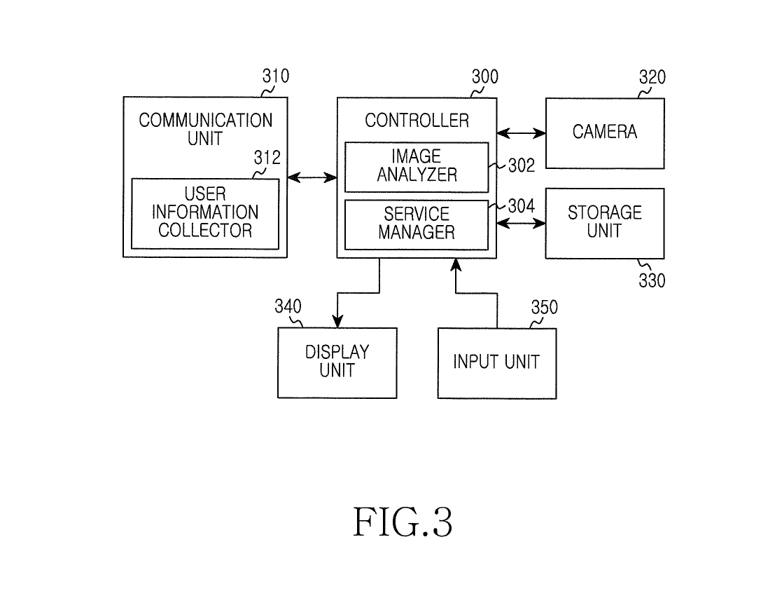

FIG. 3 illustrates an example TV according to an embodiment of the present disclosure.

Referring to FIG. 3, the TV includes a controller 300, a communication unit 310, a camera 320, a storage unit 330, a display unit 340, and an input unit 350. More particularly, the controller 300 includes an image analyzer 302 and a service manager 304. The communication unit 310 includes a user information collector 312.

The controller 300 controls and processes the operation of the TV. According to an embodiment of the present disclosure, the controller 300 determines the number of users in the vicinity of the TV, collects user information from a nearby terminal to determine whether to provide a personal service or provide a common service, and collects user operating information from the nearby terminal(s) to provide the personal service or the common service.

In detail, the image analyzer 302 of the controller 300 analyzes an image inputted from the camera 320 in real-time, and determines whether a user exists in the vicinity of the TV. When a user exists in the vicinity of the TV, the image analyzer 302 controls the user information collector 312 to collect user information from the nearby terminal by informing the communication unit 310 of the existence of a user. In addition, when a user exists in the vicinity of the TV, the image analyzer 302 determines the number of users included in an image inputted from the camera 320, and provides a signal representing the determined number of users to the service manager 304. Here, the image analyzer 302 may detect a facial region from the input image to determine the existence of the user and the number of users.

In addition, the service manager 304 of the controller 300 determines whether to provide a personal service or provide a common service based on the number of users provided from the image analyzer 302 and user information provided from the user information collector 312. The controller 300 collects user operating information from the user information collector 312 to provide a personal service or a common service depending on the user operating information. That is, when the controller 300 determines that an input signal from the image analyzer 302 indicates that one user exists in the vicinity of the TV along with a signal representing that user information is not received is inputted from the user information collector 312, the service manager 304 determines not to provide the personal service and the common service. In contrast, when the controller 300 determines that an input signal indicates that one user exists in the vicinity of the TV is inputted from the image analyzer 302 along with user information that is inputted from the user information collector 312, the service manager 304 determines to provide the personal service for one user existing in the vicinity of the TV. At this point, when the user information inputted from the user information collector 312 includes information regarding one user, the service manager 304 collects user operating information from a terminal corresponding to the inputted user information to provide the personal service. In contrast, when the user information inputted from the user information collector 312 includes information regarding two or more users, the service manager 304 collects user operating information from a nearby terminal to determine that it is currently in use and collects user operating information received from the terminal to provide the personal service.

In contrast, when the controller 300 determines that an input signal indicates that a plurality of users exist in the vicinity of the TV is inputted from the image analyzer 302 along with a signal representing that user information has not been inputted from the user information collector 312, the service manager 304 determines not to provide the personal service and the common service. In contrast, when the controller 300 determines that an input signal indicating that a plurality of users exist in the vicinity of the TV is inputted from the image analyzer 302 along with user information that is input from the user information collector 312, the service manager 304 determines to provide the common service for users existing in the vicinity of the TV. At this point, when the user information inputted from the user information collector 312 includes information regarding one user, the service manager 304 collects user operating information from the terminal corresponding to the inputted user information to provide the common service. In contrast, when the user information inputted from the user information collector 312 includes information regarding two or more users, the service manager 304 collects user operating information from nearby terminals to analyze a common interest, and then provides a common service corresponding to the common interest. At this point, the service manager 304 may determine a terminal currently in use based on user operating information of the nearby terminal, analyze a common interest using user operating information received from the terminal currently in use, and then provide the common service.

In addition, the service manager 304 may determine whether a current user in the vicinity of the TV is a user carrying the terminal based on whether the terminal is currently in use along with login information among the user operating information, and analyze which application is frequently used by that user while the user views the TV based on information of applications currently in use to determine the user's interest. In addition, the service manager 304 may determine a user interest based on a search keyword exists among the user operating information, and display whether a message is transmitted or received or whether a call is received or transmitted on the display unit 340 using message transmission/reception information and call reception/transmission information. In addition, the service manager 304 receives communication counterpart information to display contents (e.g., a name, a phone number, a photo, recent state information, and the like) related to a counterpart that is currently communicated by a terminal on the display unit 340.

The communication unit 310 transmits or receives signals for communication with an external device under control of the controller 300. The communication unit 310 receives broadcast signals of a selected channel to provide the same to the controller 300 under control of the controller 300. In addition, the communication unit 310 transmits signals requesting user information to a nearby terminal via the user information collector 312 and receives user information and user operating information from the nearby terminal under control of the controller 300 to provide the same to the controller 300. Here, user information refers to user identification information such as a user's phone number and a user's name, and the user operating information denotes various information related to an operation of a terminal, such as whether a terminal is currently in use, login information, information regarding applications currently in use, a search keyword, message transmission/reception information, call reception/transmission information, communication counterpart information, etc.

The camera 320 provides an image inputted via a camera sensor to the controller 300 in real-time.

The storage unit 330 stores various programs required for operating the TV and data associated with the TV or portable terminal. More particularly, the storage unit 330 may store user information and user operating information collected via the user information collector 312.

The display unit 340 displays various state information, numbers, characters, and images during operation of the TV under control of the controller 300. That is, the display unit 340 displays broadcast images received and decoded via the communication unit 310. More particularly, the display unit 340 displays image signals depending on the personal service and the common service.

The input unit 350 includes at least one function key or a touch sensor to provide data corresponding to a key pressed by a user to the controller 300, or provide coordinate data corresponding to a position touched by the user to the controller 300. In addition, the input unit 350 may include a separate function key for turning on or off a service that uses the portable terminal. When the relevant function key is pressed, the input unit 350 informs the controller 300 that the relevant function key is pressed. Of course, the TV may configure a separate menu for turning on or off a particular service that uses a portable terminal, and turn on or off the service that uses the portable terminal when the menu is selected by a user.

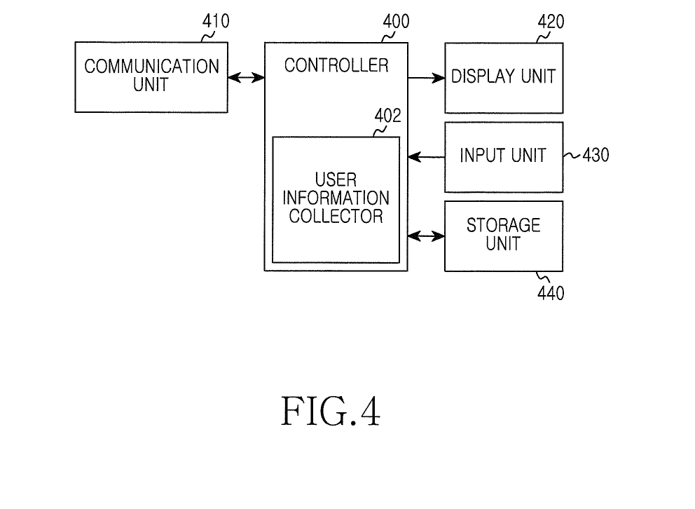

FIG. 4 illustrates an example portable terminal according to an embodiment of the present disclosure.

Referring to FIG. 4, the terminal includes a controller 400, a communication unit 410, a display unit 420, an input unit 430, and a storage unit 440. More particularly, the controller 400 includes a user information collector 402.

The controller 400 controls and processes the operation of the terminal. According to an embodiment of the present disclosure, the controller 400 transmits user information and user operating information to the TV in response to a request from the TV. That is, when user information is requested from the TV, the user information collector 402 of the controller 400 transmits information (e.g., a phone number and/or a name) regarding a user of the terminal, and detects an operation of the terminal to collect information related to the operation, that is, user operating information (e.g., whether a terminal is currently in use, login information, information of applications currently in use, a search keyword, message transmission/reception information, call reception/transmission information, communication counterpart information, and the like) and transmit the same.

The communication unit 410 transmits or receives signals for communicating with an external apparatus under control of the controller 400. More particularly, the communication unit 410 receives user information request signals from the TV to provide the same to the controller 400, and receives user information and user operating information from the controller 400 to transmit the same to the TV.

The display unit 420 displays various state information, numbers, characters, and images occurring during operation of the terminal. The display unit 420 may display a message asking whether to receive a cooperation service with the TV under control of the controller 400.

The input unit 430 includes at least one function key or a touch sensor, and provides data corresponding to a key pressed by a user to the controller 400, or provides coordinate data corresponding to a position touched by the user to the controller 400. The input unit 430 may receive input from a user whether the portable terminal is to provide a cooperation service with the TV. In addition, the input unit 430 may include a separate function key for turning on or off a cooperation service with the digital TV. That is, when the relevant function key is pressed, the controller 400 may alternatively provide the cooperation service with the TV.

The storage unit 440 stores various programs required for operating the terminal, and data associated with operation of the portable terminal. More particularly, the storage unit 440 may store the user information and the user operating information under control of the controller 400.

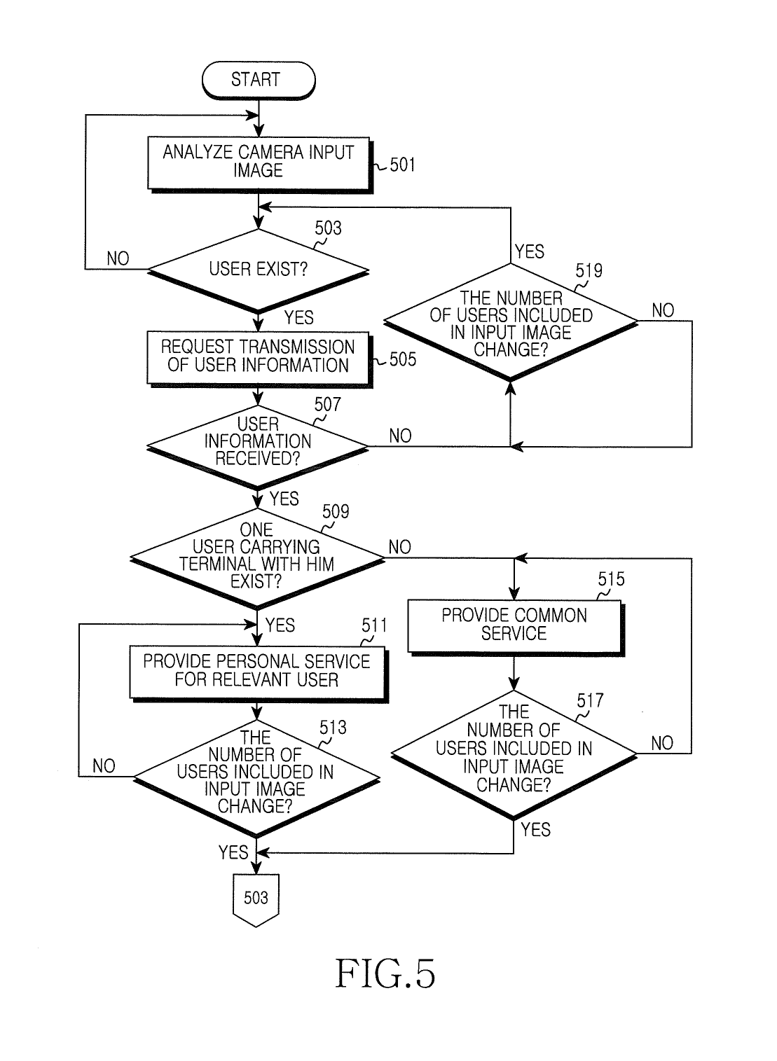

FIG. 5 illustrates an example procedure for operating a TV according to an embodiment of the present disclosure.

Referring to FIG. 5, the TV analyzes an image inputted from a camera in step 501, and in step 503, determines whether a user exists as a result of analyzing the input image. When the user does not exist in the input image, the TV returns to step 501.

In contrast, when a user exists in the input image, the TV transmits a signal requesting a nearby terminal to transmit user information in step 505. The TV then determines whether the user information is received in step 507.

When the user information is not received, the TV determines that a user carrying a terminal does not exist in the vicinity and analyzes an image input in real-time from the camera and determine whether the number of users included in the input image changes in step 519. That is, the TV determines whether the number of users has changed. When the number of users included in the input image has changed, the TV continues processing at step 503.

However, when the user information is received in step 507, the TV determines whether one user carrying a terminal exists in the vicinity of the TV in step 509. When one user exists in the image inputted via the camera and the user information is received, the TV may determine that one user carrying the terminal with him exists.

When one user carrying the terminal exists in the vicinity of the TV, the TV provides a personal service for the one user in step 511. At this point, the TV may provide a service related to the user's private life based on the user operating information received in real-time from the terminal.

In step 513, the TV analyzes an image inputted in real-time from the camera and determines whether the number of users included in the input image has changed. That is, the TV determines whether the number of nearby users changes. When the number of users included in the input image does not change, the TV continues processing at step 511 to continue to provide a personal service for the single user. However, when the number of users included in the input image changes, the TV stops providing the personal service and continues processing at step 503.

However, when one user carrying the terminal does not exist in the vicinity of the TV and a plurality of users exists as a result of the determining step depicted in step 509, the TV continues processing at step 515 to provide a common service for the plurality of users determined in step 507. That is, the TV determines a common interest of the users based on user operating information received in real-time from nearby terminals, and then provides a common service corresponding to the common interest.

At step 517, the TV analyzes an image inputted in real-time from the camera to determine whether the number of users included in the input image has changed. That is, the TV determines whether the number of nearby users changes. When the number of users included in the input image does not change, the TV continues processing at step 511 to provide the common service for the relevant users. However, when the number of users included in the input image changes, the TV stops providing the common service and continues processing at step 503.

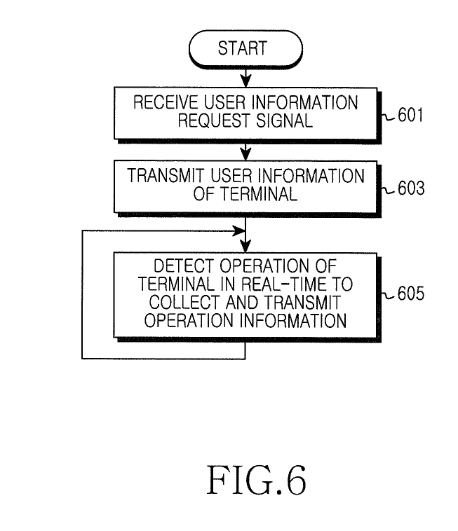

FIG. 6 illustrates an example procedure for operating a portable terminal according to an embodiment of the present disclosure.

Referring to FIG. 6, the terminal receives a signal requesting user information from a TV in step 601, and transmits the user information of the terminal in step 603. The user information may include user identification information such as the user's phone number and the user's name.

The terminal detects its operating status in real-time to collect information related to the operation, that is, user operating information and transmit the same to the TV in step 605. Here, the user operating information includes various information related to operation of the terminal, such as whether a terminal is currently in use, login information, information regarding applications currently in use, a search keyword, message transmission/reception information, call reception/transmission information, communication counterpart information, etc. At this point, the terminal may continue to collect and transmit the user operation information until a power off event of the TV occurs, or a separate end event occurs. The end event may occur when a signal representing a user operation information transmission end is received from the TV or according to manual control of the user.

In the above, although description has been made to the case where a TV requests a nearby terminal to transmit user information when a user exists in the vicinity of the TV and the nearby terminal transmits user information to the TV, the nearby terminal in the vicinity of the TV may automatically transmit the user information to the TV without a request of the TV.

According to an embodiment of the present disclosure, a TV determines the number of nearby users via a camera, receives user information from a portable terminal to determine whether to provide a personal service for a user or provide a common service for multiple users. In the case where one user carrying a portable terminal exists in the vicinity of the TV, the TV provides the personal service. In the case where a plurality of users exist in the vicinity of the TV, the TV provides only the common service such that individual privacy of a user may be protected. The TV collects user operating information from the portable terminal, and provides a service corresponding to the collected operating information, thereby providing a service suitable for a user's characteristic.

Although the disclosure has been shown and described with reference to certain embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. A method for providing a service using a portable terminal in communication with a television (TV), the method comprising:
analyzing an image inputted from a camera to determine a number of users;
collecting user information from one or more terminals associated with the one or more users; and
determining a type of the service to be provided based on the number of users and the collected user information.

2. The method of claim 1, wherein determining of the type of the service to be provided comprises:
determining the number of users each carrying one of the one or more terminals in a vicinity of the TV based on the number of users and the collected user information; and
when the number of users is one user carrying the one of the one or more terminals exists in the vicinity of the TV, determining to provide a personal service.

3. The method of claim 2, further comprising, when a plurality of users carrying a plurality of the one or more terminals exist in the vicinity of the TV, determining to provide a common service for the plurality of users.

4. The method of claim 2, wherein determining the number of users carrying a terminal in a vicinity of the TV comprises:
when user information of the one terminal is collected when the number of users is one, determining that the one user carrying the terminal exists in the vicinity of the TV; and
when user information of the nearby terminal is not collected when the number of users is one, determining that a user carrying the terminal does not exist in the vicinity of the TV.

5. The method of claim 2, further comprising, when a user carrying the terminal does not exist in the vicinity of the TV, not providing the personal service and a common service.

6. The method of claim 1, further comprising:
receiving operating information related to an operation of the one or more terminals from the one or more terminals; and
providing the determined type of the service based on the operating information.

7. The method of claim 6, wherein the operating information comprises at least one of whether a terminal is currently in use, login information, information of applications currently in use, a search keyword, message transmission/reception information, call reception/transmission information, and communication counterpart information.

8. A method for providing a service by a portable terminal in communication with a television (TV), the method comprising:
receiving a user information request signal from the TV;
transmitting user information of the terminal to the TV; and
transmitting operating information related to an operation of the portable terminal to the TV.

9. The method of claim 8, wherein the transmitting of the operating information related to the operation of the portable terminal to the TV comprises:
detecting the operation of the terminal;
collecting information related to the operation of the terminal in real-time; and
transmitting the collected information to the TV.

10. The method of claim 8, wherein the operating information comprises at least one of whether a terminal is currently in use, login information, information of applications currently in use, a search keyword, message transmission/reception information, call reception/transmission information, and communication counterpart information.

11. A television (TV) configured to provide a service using one or more portable terminals, the TV comprising:
a camera configured to receive an image;
a communication unit configured to collect user information of the portable terminals; and
a controller configured to analyze the image inputted from the camera to determine the number of users, and to determine a type of a service to be provided based on the number of users and the collected user information.

12. The apparatus of claim 11, wherein the controller is configured to:
determine the number of users each carrying one of the one or more portable terminals in a vicinity of the TV based on the number of users and the collected user information; and
when the number of users is one, provide a personal service.

13. The apparatus of claim 12, wherein the controller is configured to provide a common service for the plurality of users when a plurality of users each carrying a portable terminal exist in the vicinity of the TV.

14. The apparatus of claim 12, wherein the controller is configured to:
determine that one user carrying the terminal exists in the vicinity of the TV when user information of the portable terminals indicates that the number of users is one; and
determine that a user carrying the portable terminal does not exist in the vicinity of the TV when user information of the portable terminal is not collected when the number of users is one.

15. The apparatus of claim 12, wherein the controller is configured to not provide the personal service and a common service when one of the plurality of user carrying the portable terminal does not exist in the vicinity of the TV.

16. The apparatus of claim 11, wherein the communication unit is configured to receive operating information related to an operation of the one or more terminals from the one or more terminals, and
the controller is configured to provide the determined type of the service based on the received operating information.

17. The apparatus of claim 16, wherein the operating information comprises at least one of whether a terminal is currently in use, login information, information of applications currently in use, a search keyword, message transmission/reception information, call reception/transmission information, and communication counterpart information.

18. A portable terminal configured to provide a service in cooperation with a television (TV), the portable terminal comprising:
a communication unit configured to transmit and receive signals to and from the TV; and
a controller configured to, when receiving a user information request signal from the TV via the communication unit, transmit user information of the portable terminal to the TV, and transmits operating information related to an operation of the portable terminal to the TV.

19. The apparatus of claim 18, wherein the controller is configured to detect an operation of the portable terminal, collect information related to the operation of the portable terminal in real-time; and transmit the collected information to the TV.

20. The apparatus of claim 18, wherein the operating information comprises at least one of whether a terminal is currently in use, login information, information of applications currently in use, a search keyword, message transmission/reception information, call reception/transmission information, and communication counterpart information.
